(19) United States
(12) Patent Application Publication
(10) Pub. No.: US 2003/0129755 A1
(43) Pub. Date: Jul. 10, 2003

(54) System and method of storing and retrieving storage elements

(75) Inventors: John Sadler, Belmont, CA (US); Michael Hogan, Tucson, AZ (US)

Correspondence Address: Pillsbury Winthrop LLP, Intellectual Property Group, Suite 200, 11682 El Camino Real, San Diego, CA, 92130-2092, US

(73) Assignee: GenVault Corporation

(21) Appl. No.: 10/252,352

(22) Filed: Sep. 20, 2002

Related U.S. Application Data
(63) Continuation-in-part of application No. 10/005,529, filed on Nov. 7, 2001.

(51) Int. Cl. G06F 7/00; G01N 35/00

(52) U.S. Cl. 436/43; 707/1; 422/109; 422/63

(57) ABSTRACT

Systems and methods of archiving and retrieving storage elements are disclosed. In some embodiments, a fully automated sample storage and retrieval system may be operative to achieve both very high storage density as well as very high sample processing throughput rates, for example, supporting throughput rates greater than one hundred samples per day. In some embodiments, a system and method may archive and retrieve a plurality of storage elements supported in a two dimensional configuration in a storage receptacle.

The present application is a continuation-in-part of non-provisional application Ser. No. 10/005,529, filed Nov. 7, 2001, entitled “APPARATUS, SYSTEM, AND METHOD OF ARCHIVAL AND RETRIEVAL OF SAMPLES.” The present application is also related to non-provisional application Ser. No. 10/005,415, filed Nov. 7, 2001, entitled “ARCHIVE AND ANALYSIS SYSTEM AND METHOD,” non-provisional application Ser. No. 10/007,355, filed Nov. 7, 2001, entitled “SAMPLE CARRIER,” non-provisional application Ser. No. 10/150,770, filed May 17, 2002, entitled “SAMPLE CARRIER RECEIVER,” and non-provisional application Ser. No. 10/150,771, filed May 17, 2002, entitled “SAMPLE CARRIER SYSTEM.” The disclosures of all the foregoing applications are hereby incorporated by reference.

### FIELD OF THE INVENTION

Aspects of the present invention relate generally to archival and retrieval of sample material, and more particularly to a system and method of storing and retrieving storage elements in a high-density sample archive facility.

### DESCRIPTION OF THE RELATED ART

In many applications such as pharmaceutical and medical research, law enforcement, and military identification, for example, it is often desirable to have access to numerous biological samples. Conventional biorepositories or other sample storage facilities utilize liquid or low temperature cryogenic systems for sample storage; these liquid and cryogenic systems are expensive both to create and to maintain. Additionally, current technology generally presents system operators with complicated and labor intensive maintenance and administrative responsibilities.

Specifically, the intricacies of cryogenic systems may typically oblige technicians, researchers, and system operators to engage in coordinated labor for weeks to retrieve and to prepare thousands of deoxyribonucleic acid (DNA) samples from whole blood. Accordingly, conventional approaches for archiving DNA in liquid or cryogenic states are fundamentally inadequate to the extent that they do not accommodate high volume processing and sample throughput. Current research trends recognize benefits associated with systems and methods of archiving and retrieving biological and non-biological samples which may be capable of processing thousands of samples per day; current cryogenic technology, however, is inadequate to attain throughput at this level. In fact, liquid or cryogenic storage facilities cannot accommodate processing throughput of one hundred or more samples per day.

Although some small volume liquid-state DNA and blood archival techniques have been useful in the past, present methodologies are not capable of supporting the increasing storage and retrieval rates required as advancing genomics technology becomes more prevalent as a research and diagnostic tool. Since the traditional cryogenic-based archival format is difficult and expensive to automate, systems based upon existing technology are generally not amenable to the high throughput demands of the market.

Recently, biological research laboratory systems have been proposed which incorporate archival and retrieval of blood samples in dry or desiccated form. Typical systems employing conventional technology are generally based upon modifications or variations of known techniques for storing DNA or other organic samples on a suitable substrate such as filter paper. Improved systems and methods incorporating automated archival and retrieval of biological and non-biological sample material have been disclosed in the related co-pending applications noted above.

In particular, full automation of the storage and retrieval processes in sample archival systems may employ robotics and other machinery operating repeatedly to identify, to retrieve, and to replace individual storage elements within a large volume storage room or vault.

In a storage and retrieval system, it is usually important for economic reasons to maximize the storage density, i.e. the quantity of items stored per unit volume, footprint area, or cost. Conventional commercial storage and retrieval systems usually consist of an array of bins, shelves, or trays mounted in a regular array with some mechanism for retrieving an individual storage element and placing it in a position where a robot or an operator can select samples. Common automated embodiments include:

carousels, in which rows or columns of storage elements are connected in a loop and rotated past a window;

vertical lifts, in which the storage element is embodied in a removable unit located in a rack, and wherein an elevator mechanism removes a selected unit from the rack and translates it to a fixed window for use; and

pigeonholes, generally comprising a planar array of slots, each of which may store one item or storage element.

Pigeonhole systems are most commonly used in situations where each of the plurality of items to be stored is similar in size and shape. In this case, a Cartesian manipulator traverses the array to move items between the pigeonholes and a fixed access point. Typically, there are two planes of slots, analogous to a pair of facing bookshelves.

Commercial versions of such storage systems are supplied at a fixed minimum pitch, or spacing between storage elements. When storing items which have a thickness less than the minimum pitch, storage density is reduced due to wasted space between storage elements. Generally, what is needed is an archival and retrieval system and method allowing greater use of available volume for storing laboratory storage elements and other regularly shaped objects.

### SUMMARY

Embodiments of the present invention overcome various shortcomings of conventional technology, providing a system and method of automated archival and retrieval of biological, non-biological, or chemical samples in a high-density storage facility. In accordance with one aspect of the invention, for example, a fully automated sample storage and retrieval system may be operative to achieve both very high storage density as well as very high sample processing throughput rates, for example, supporting throughput rates greater than one hundred samples per day.

In accordance with one exemplary embodiment, an archive generally comprises a receptacle having a support surface; and a plurality of storage elements arranged in a two dimensional configuration on the support surface; each of the plurality of storage elements may be individually addressable (uniquely addressed in three dimensional space) and directly accessible (accessed without any intervening or preliminary handling operations directed at other storage elements).

An archive may further comprise a handling apparatus selectively operative to engage targeted ones of the plurality of storage elements, which may be oriented on end, for example, or stacked so as to create a three dimensional configuration of storage elements. In a stacked arrangement, each of the plurality of storage elements may include interlocking structural features operative to prevent relative movement when the storage elements are stacked. Additionally or alternatively, a stabilizing structure may extend from the support surface to prevent relative movement of the storage elements when stacked. In the stacked embodiment, the handling apparatus may selectively engage a targeted one of the plurality of storage elements and manipulate that targeted one as well as ones of the plurality of storage elements stacked thereon as a unit.

In accordance with another aspect of the invention, the depth of any given storage element may vary relative to the respective depths of other storage elements. Additionally, an archive may further comprise a data structure maintaining information associating each of the plurality of storage elements with a unique storage address.

In some embodiments, an archive may comprise a receptacle supporting a plurality of storage elements arranged in a two dimensional configuration of stacks; and a handling apparatus selectively operative to access a targeted one of the plurality of storage elements directly. In other words, no preliminary or intervening handling operations are required to access any targeted storage element in any particular stack. In such an archive, each of the plurality of storage elements may be individually addressable to facilitate the foregoing operation.

As with the embodiments noted above, an archive receptacle may comprise a stabilizing structure operative to prevent relative movement of stacked storage elements. Further, the handling apparatus may be selectively operative to manipulate a targeted storage element as well as ones of the plurality of storage elements stacked thereon as a unit.

In some embodiments, the depth of any given storage element may vary relative to others of the plurality of storage elements. The foregoing data structure maintaining information associating each of the plurality of storage elements with a unique storage address may also be incorporated in this embodiment.

In accordance with another aspect of the invention, a method of archiving a storage element generally comprises: providing a storage element; identifying a candidate storage location in a two dimensional configuration in a receptacle; assigning an address representing the candidate storage location to the storage element; and placing the storage element in the receptacle at the address responsive to the identifying and the assigning.

In this context, the providing may comprise, among other things, loading sample material to be archived into the storage element, sealing the storage element, and so forth. Identifying a candidate storage location may comprise, among other things, retrieving data records associated with the candidate storage location and the receptacle from a data structure, confirming that the candidate storage location is unoccupied and unreserved, and confirming that the candidate storage location satisfies requirements of sample material in the storage element.

Assigning an address may generally comprise associating the address with the storage element and writing information regarding the associating in a data storage medium such as may be maintained at an archive facility, for example. Additionally, a method of archiving in accordance with the present disclosure may comprise updating data record fields associated with the address in a data storage medium.

Placing the storage element in the receptacle may comprise utilizing a handling apparatus such as described above to manipulate the storage element into a selected position and orientation at the address. In some embodiments, the receptacle supports a two dimensional configuration of stacked storage elements, and accordingly, the identifying comprises selecting a candidate storage location in three dimensional space in the receptacle. The foregoing placing operation may also comprise utilizing a handling apparatus operative to manipulate the storage element into a selected position and orientation at the address.

In accordance with another aspect of the present invention, a method of retrieving a storage element comprises: identifying a storage element maintaining a selected sample; locating the storage element at an address in a two dimensional configuration in a receptacle; translating a handling apparatus to the address at the receptacle; and retrieving the storage element in accordance with the identifying and the locating.

In this context, the identifying operation may comprise retrieving data records associated with the storage element from a data structure, and the locating operation may comprise retrieving data records from the data structure, the data records being associated with at least one of the storage element, the address, and the receptacle. Additionally, a method of retrieving a storage element may further comprise updating data records associated with the address in the data structure.

In some embodiments set forth in more detail below, the translating operation comprises selecting the handling apparatus in accordance with a storage strategy employed at the receptacle.

In some implementations noted above, a receptacle supports a two dimensional configuration of stacked storage elements; accordingly, the locating may generally comprise selecting a storage element in three dimensional space in the receptacle. The retrieving operation may comprise utilizing a handling apparatus operative to manipulate the storage element and additional storage elements stacked thereon as a unit.

In accordance with another exemplary embodiment, an archive comprises: a receptacle having a support surface; and a plurality of storage elements arranged in a two dimensional configuration on the support surface, wherein each of the plurality of storage elements is individually addressable and directly accessible.

As with the archives described briefly above, this embodiment may further comprise a handling apparatus selectively operative to engage targeted ones of the plurality of storage elements, which may be oriented on end or stacked. In the stacked embodiment, each of the plurality of storage elements may include interlocking structural features operative to prevent relative movement of the storage elements when stacked. Storage elements of varying depth are contemplated as noted above.

An archive may comprise a handling apparatus selectively operative to engage a targeted storage element and to manipulate that targeted storage element and ones of the plurality of storage elements stacked thereon as a unit.

Accordingly, another embodiment of an archive may generally comprise: a receptacle having a support surface; a plurality of storage elements arranged in a two dimensional configuration of stacks on the support surface, wherein each of the plurality of storage elements is individually addressable; and a handling apparatus selectively operative to engage a targeted one of the plurality of storage elements and to manipulate the targeted one of the plurality of storage elements and ones of the plurality of storage elements stacked thereon as a unit.

In some embodiments, the handling apparatus is operative to access targeted ones of the plurality of storage elements directly, i.e. without first accessing or otherwise engaging others of the plurality of storage elements. In such an embodiment employing stacked storage elements, each storage element may include interlocking structural features operative to prevent relative movement of the storage elements when stacked. Additionally or alternatively, the archive may comprise a stabilizing structure extending from the support surface to prevent relative movement of the stacked storage elements.

As with the embodiments noted above, the depth of each storage element may vary relative to the depth of other storage elements. An archive configured and operative in accordance with the present disclosure may further comprise a data structure maintaining information associating each of the plurality of storage elements with a unique storage address.

The foregoing and other aspects of various embodiments of the present invention will be apparent through examination of the following detailed description thereof in conjunction with the accompanying drawings.

### BRIEF DESCRIPTION OF THE DRAWINGS

FIG. 1 is a simplified block diagram illustrating one embodiment of an automated sample archival and retrieval system.

FIG. 2 is a simplified block diagram illustrating the general operation of one embodiment of an automated sample archival and retrieval system.

FIG. 3 is a simplified block diagram illustrating components of one embodiment of a sample archive facility and automated archive management system.

FIG. 4A is a simplified perspective diagram of one embodiment of a sample storage component configured and operative for use in an archive facility.

FIG. 4B is a simplified perspective diagram illustrating one embodiment of a receptacle configured and operative for use in conjunction with a sample storage component.

FIG. 4C is a simplified perspective diagram illustrating another embodiment of a receptacle configured and operative for use in conjunction with a sample storage component.

FIGS. 5A through 5D are simplified block diagrams illustrating elevation views of one embodiment of a storage element handling apparatus in operation.

FIG. 6 is a simplified flow diagram illustrating the general operation of one embodiment of a procedure to archive a storage element.

FIG. 7 is a simplified flow diagram illustrating the general operation of one embodiment of a procedure to remove a storage element from a sample storage receptacle.

FIG. 8 is a simplified diagram illustrating one embodiment of a sample carrier and a sample carrier receiver.

FIGS. 9A and 9B are simplified diagrams illustrating one embodiment of a sample carrier and one embodiment of a sample carrier receiver, respectively.

### DETAILED DESCRIPTION

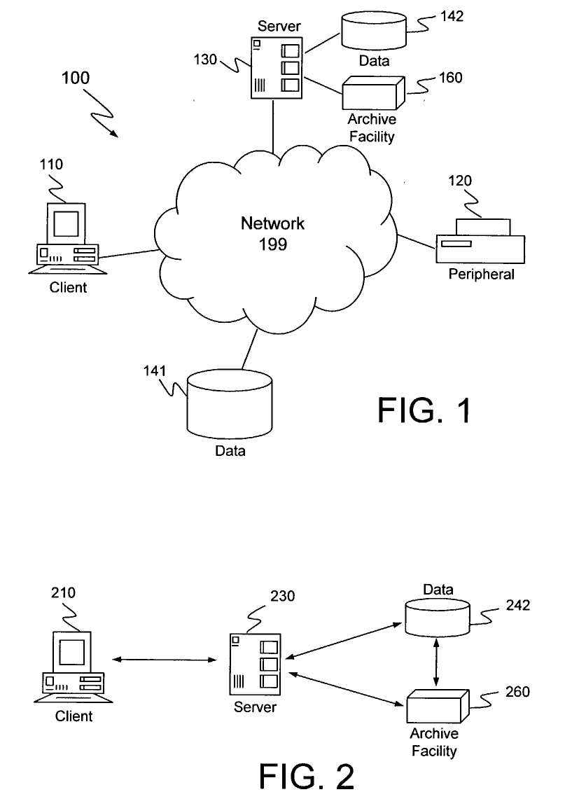

Turning now to the drawings, FIG. 1 is a simplified block diagram illustrating one embodiment of an automated sample archival and retrieval system. In the exemplary FIG. 1 embodiment, system 100 generally comprises one or more remote computers or terminals, such as network client 110, coupled to one or more servers, such as server 130, via a communications network 199. System 100 may also comprise data storage media and peripheral equipment, represented by reference numerals 141 and 120, respectively.

For clarity, only one server 130 and one client 110 have been depicted in FIG. 1. Those of skill in the art will appreciate that the arrangement illustrated in FIG. 1 is presented for illustrative purposes only, and that system 100 may be implemented with any number of additional servers, clients, or other components; the number and variety of each device coupled to network 199 may vary in accordance with system requirements. In some embodiments, the functionality of one device, such as peripheral device 120, for example, may reside on or be enabled by another device, such as server 130.

In operation, client 110 may be capable of two-way data communication via communications network 199. In that regard, client 110 may communicate with server 130, peripheral device 120, and data storage medium 141 via network 199 or via one or more additional networks (not shown) which may be coupled to network 199. It will be appreciated by those of skill in the art that client 110, server 130, and other components depicted in FIG. 1 may be coupled via any number of additional networks without inventive faculty.

In some embodiments, client 110 may be a personal computer or workstation, a personal digital assistant (PDA), a wireless telephone, or other network-enabled computing device, electronic apparatus, or computerized system. In operation, client 110 may execute software or other programming instructions encoded on a computer-readable storage medium, and additionally may communicate with server 130, data storage medium 141, and peripheral device 120 for monitor and control applications. For example, client 110 may interrogate server 130 and request transmission of data maintained at data storage medium 142 coupled to, or accessible by, server 130. Additionally or alternatively, client 110 may transmit control signals or requests which may cause device 120 to take some action or to execute a specified function or program routine.

It is well understood in the art that any number or variety of peripheral equipment, such as device 120, may additionally be coupled to network 199 without departing from the essence of the present disclosure. Examples of such peripheral devices include, but are not limited to: servers; computers; workstations; terminals; input/output devices; laboratory equipment; printers; plotters; routers; bridges; cameras or video monitors; sensors; actuators; or any other network-enabled device known in the art. Peripheral device 120 may be coupled to network 199 directly, as illustrated in FIG. 1, or indirectly, for example, through server 130, such that the functionality or operation of device 120 may be influenced or controlled as described below by hardware or software resident on server 130.

As is generally known in the art, server 130 may be embodied or implemented in a single physical machine, for example, or in a plurality of distributed but cooperating physical machines. In operation, server 130 may incorporate all of the functionality of a file server or application server, and may additionally be coupled to data storage medium 142 and sample archive facility 160.

In that regard, information and data records maintained at data storage medium 142 and sample archive facility 160 may be accessible to client 110 through bi-directional data communication with server 130 via network 199.

Network 199 may be any communications network known in the art including, for example: the internet; a local area network (LAN); a wide area network (WAN); a Virtual Private Network (VPN); or any system providing data communication capability between client 110, server 130, storage medium 141, and peripheral device 120. In some embodiments, encryption technology and other security measures provided by a VPN implementation may prevent remote terminals from gaining unauthorized access to proprietary information, as is generally known in the art of network architecture. In addition, network 199 may be configured in accordance with any topology known in the art, including star, ring, bus, or any combination thereof.

By way of example, the data connection between components in FIG. 1 may be implemented as a serial or parallel link. Alternatively, the data connection may be any type generally known in the art for communicating or transmitting data across a computer network; examples of such networking connections and protocols include, but are not limited to: Transmission Control Protocol/Internet Protocol (TCP/IP); Ethernet; Fiber Distributed Data Interface (FDDI); ARCNET; token bus or token ring networks; Universal Serial Bus (USB) connections; and Institute of Electrical and Electronics Engineers (IEEE) Standard 1394 (typically referred to as “FireWire”) connections.

Other types of data network interfaces and protocols are within the scope and contemplation of the present disclosure. In particular, client 110 may be configured to transmit data to, and receive data from, other networked components using wireless data communication techniques, such as infrared (IR) or radio frequency (RF) signals, for example, or other forms of wireless communication. Accordingly, those of skill in the art will appreciate that network 199 may be implemented as an RF Personal Area Network (PAN).

Storage media 141,142 may be conventional read/write memory such as a magnetic disk drive, a magneto-optical drive, an optical disk drive, a floppy disk drive, a compact-disk read only memory (CD-ROM) drive, a digital versatile disk read only memory (DVD-ROM), a digital versatile disk random access memory (DVD-RAM), transistor-based memory, or other computer-readable memory device for storing and retrieving data.

Sample archive facility 160 may be arranged and configured to maintain a multiplicity of biological or non-biological samples as set forth in more detail below. Additionally, archive facility 160 may include mechanical and robotic systems configured and operative to manipulate samples and to facilitate washing, purification, testing, packaging, and shipping thereof. Various testing devices, experimental apparatus, and research equipment may have access to the samples maintained at archive facility 160. Computer hardware and software resident at, or operatively coupled to mechanical and other components at, archive facility 160 may communicate with server 130 as illustrated in FIG. 1. In the exemplary FIG. 1 embodiment, archive facility 160 represents the foregoing samples, equipment, robotics, devices, and computer hardware and software, as well as a network interface enabling bi-directional data communication between computer components in archive facility 160 and server 130.

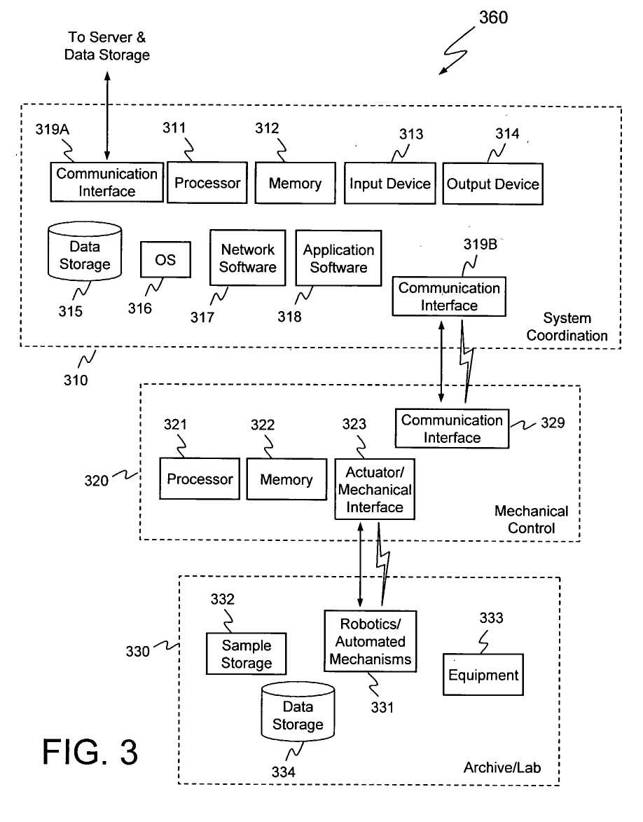

FIG. 2 is a simplified block diagram illustrating the general operation of one embodiment of an automated sample archival and retrieval system. As illustrated in FIG. 2, client 210 may generally correspond to client 110 depicted and described above with reference to FIG. 1. Similarly, server 230, storage medium 242, and sample archive facility 260 may correspond to server 130, storage medium 142, and archive facility 160, respectively. The components in the FIG. 2 arrangement may incorporate all of the respective functionality set forth above.

Responsive to requests or instructions from client 210, for example, server 230 may be operative to retrieve data or information from storage medium 242 and archive facility 260. Storage medium 242 may comprise a database, for instance, or other data structure configured to maintain data records and other information related to some or all of the following: the number and type of samples maintained in archive facility 260; sample origins or sources; testing or research procedures or protocols; operational parameters of various components incorporated in archive facility 260; and access authorization, passwords, billing information, and the like associated with client 210. The foregoing list is provided by way of example only, and is not intended to be inclusive.

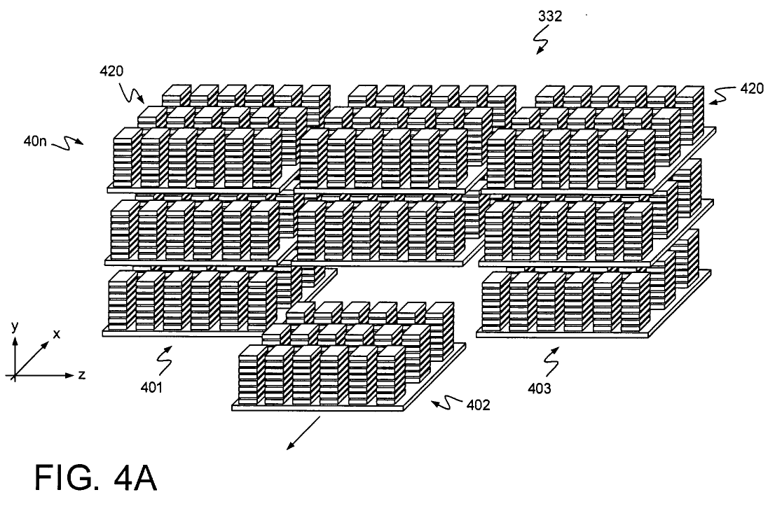

As illustrated in FIG. 2, storage medium 242 and archive facility 260 may be configured to engage in two-way data communication such that computer hardware or systems at archive facility 260 may read data records from, and write data to, storage medium 242. Alternatively, as illustrated and described below with reference to FIG. 3, various data storage media may be incorporated in archive facility 260, for example.

FIG. 3 is a simplified block diagram illustrating components of one embodiment of a sample archive facility and automated archive management system. The exemplary FIG. 3 sample archive facility 360 may generally correspond to archive facilities 160 and 260 described above with reference to FIGS. 1 and 2, respectively, and may incorporate all of the functionality and operational characteristics set forth above. Archive facility 360 may generally comprise a system coordination component (coordinator) 310, a mechanical systems control component (controller) 320, and an archive and laboratory component (archive) 330.

System coordinator 310 may include computer hardware and software configured to manipulate or to instruct other system elements as set forth in detail below. Accordingly, coordinator 310 may be embodied in a computer server or other electronic control system, for example, and may be configured to run a multi-tasking operating system (OS 316) as is generally known in the art. Coordinator 310 generally comprises at least one processor 311 coupled to other components described below via a system bus (not shown). Processor 311 may be any microprocessor or microcontroller-based microcomputer known in the art, or designed and operative in accordance with known principles.

The software code or programming instructions for controlling the functionality of processor 311 may be encoded in memory 312 and, additionally or alternatively, stored in storage medium 315. Memory 312 and storage medium 315 may be any computer-readable memory known in the art, as discussed above with reference to storage media 141,142. Additionally or alternatively, some software or instruction code related to operation of processor 311 may reside at a remote device or storage medium 242 as described above with reference to FIG. 2. Network interface hardware and software, such as represented by communication interface 319A and network software 317, respectively, may facilitate the foregoing network communication, and may generally enable any interface known in the art for communicating or transferring files across a computer network as set forth in detail above.

Processor 311 may communicate via the system bus with a plurality of peripheral equipment, including network interface 319A, for example, enabling two-way network data communications as described above. Additional peripheral equipment may be incorporated in or coupled to coordinator 310; in some embodiments, such peripheral equipment may include an input device 313 and an output device 314 enabling a system administrator, researcher, or other technician to interface with coordinator 310 for monitor and control purposes. Examples of peripheral input/output devices may include the following: conventional keyboards, keypads, trackballs, or other input devices; visual displays such as cathode ray tube (CRT) monitors, liquid crystal display (LCD) panels, touch-sensitive screens, or other monitor devices known in the art for displaying graphical images and text; microphones or other audio or acoustic sensor devices; audio speakers; and the like. It will be appreciated by those of skill in the art that peripheral equipment may include suitable digital-to-analog and analog-to-digital conversion circuitry (not shown), as appropriate.

In operation, coordinator 310, under control of processor 311 and OS 316, for example, may execute instruction code or application software 318 configured and operative to provide desired functionality for archive facility 360 as a whole. In some embodiments, for instance, archive facility 360 may be configured to locate and to retrieve selected biological or non-biological samples and to prepare the same for shipping to a remote site for experimentation or further storage. Additionally or alternatively, various components of archive facility 360 may be employed to perform selected experiments with, or related to, retrieved samples. Overall functionality of archive facility 360 may be selectively altered or controlled in accordance with data and computer executable instructions, OS 316, and application software 318 under control of processor 311. In an alternative embodiment, much of the automated functionality of archive facility 360 described below may be manual, or provided by a researcher or technician, for example.

Coordinator 310 may communicate with controller 320 via data signals transmitted through communication interface 319B. In that regard, controller 320 may incorporate a communication interface 329 operative to enable bi-directional data communication with coordinator 310. In one embodiment, the data interface between coordinator 310 and controller 320 may be implemented in the form of a wire-line (i.e. “hard-wired”) connection, as represented by the double-headed arrow in FIG. 3. By way of example, the data connection may be a serial, parallel, or Ethernet link, or any other type of communication coupling, such as described above, generally known in the art for communicating or transmitting data across a computer network.

Other types of data interfaces and protocols are contemplated as described above. In particular, as represented by the “lightning bolt” symbol in FIG. 3, coordinator 310 may be configured to transmit data to, and receive data from, controller 320 using wireless IR or RF signals, for example, or other forms of wireless communication. In a wireless embodiment, coordinator 310 and controller 320 may be capable of communicating via the Bluetooth(TM) standard, for example.

Controller 320 may additionally include a processor 321, memory 322, and a mechanical interface 323, all of which may be coupled to communication interface 329 via a bus (not shown), as is generally known in the art. Though not illustrated in the FIG. 3 embodiment, controller 320 may additionally incorporate or be coupled to a data storage medium, which may store data and configuration instructions related to overall operation of controller 320.

Software code, configuration information, or programming instructions related to or influencing the functionality of processor 321 may be encoded in memory 322, for example; additionally or alternatively, processor 321 may receive data and instructions from coordinator 310 via communication interface 329, or from an additional data source as described above.

In operation, controller 320 may transmit control signals or other data and instructions to affect operation of a device, apparatus, machine, robotic equipment, or other mechanism via mechanical interface 323. The bidirectional data communication interface between controller 320 and the apparatus to be controlled may generally correspond to the data interfaces and protocols described above. As indicated in FIG. 3, controller 320 and the machinery to be monitored or controlled may be coupled via wire-line or wireless communication connections.

It will be appreciated that controller 320 may include one or more additional mechanical interfaces 323, depending upon a variety of factors such as the number of mechanisms to be controlled, the overall capabilities of processor 321, the capacity of memory 322, the data transmission bandwidth of mechanical interface 323, and the desired functionality of the archive facility 360, for example. Additionally or alternatively, archive facility 360 may comprise one or more additional controllers operative to manipulate or to control additional mechanisms; in one embodiment, for example, each machine or device maintained at archive facility 360 may be controlled by a respective dedicated control component such as controller 320.

In the FIG. 3 embodiment, robotic equipment or other mechanisms (robotics 331) to be monitored or controlled by controller 320 are represented as maintained or housed within archive 330. In addition to robotics 331 and associated computer hardware and software required for operation thereof, archive 330 may generally comprise a biological or non-biological sample archive (sample storage component 332), instrumentation and equipment 333, and data storage medium 334.

As depicted in the high-level FIG. 3 block diagram, equipment 333 generally represents a wide array of experimental apparatus and instrumentation, laboratory supplies and functional paraphernalia, and the like; the type, construction, and overall configuration of equipment 333 maintained at archive 330 may be a function of the intended operational characteristics of archive facility 360, the state and organization of the samples maintained in sample storage 332, and other factors. Examples of equipment 333 may include test tubes, microtiter or other multi-well plates, laboratory pipettes, storage vessels, shipping boxes and other packaging materials, scales or balances, and so forth. Those of skill in the art will appreciate that the scope of the present disclosure is not limited by the nature or characterization of equipment 333, and that different types of apparatus may be required in accordance with the desired functionality of archive facility 360.

In some embodiments, for example, archive facility 360 may serve as a large scale repository and source for biological or non-biological samples; accordingly, equipment 333 in such an embodiment may include appropriate containers or receptacles for accommodating samples during shipping, packing material and shipping boxes or envelopes, scales or balances for weighing samples or shipping materials, and so forth. Additionally or alternatively, archive facility 360 may be constructed and operative to serve as a central laboratory or experimental services provider. In this latter embodiment, robotics 331 may include proprietary or standardized laboratory modules dedicated to performing specific experiments with biological and non-biological samples, for instance, and equipment 333 may include pipettes and other liquid containers, microtiter plates constructed to receive multiple samples, antigens, reagents and other chemicals, and the like.

Robotics 331 in the FIG. 3 embodiment of archive facility 360 may represent a wide range of equipment and devices such as, for example: control modules implemented in computer hardware or software; computer-based or electronically controlled machinery, servos, hydraulic, systems, and the like; electronic circuits; peripheral equipment such as autoclaves, thermocyclers, or centrifuges; and any other devices to be controlled by controller 320 via mechanical interface 323. In some biological or non-biological sample archives, for example, robotics 331 may include or be embodied in machine vision apparatus, optical sensors or scanners, bar code readers, and the like, which may identify particular samples from among the plurality of samples in sample storage 332; this identification may be automatic, for example, or under control of an operator or administrator through input/output devices 313,314 at coordinator 310.

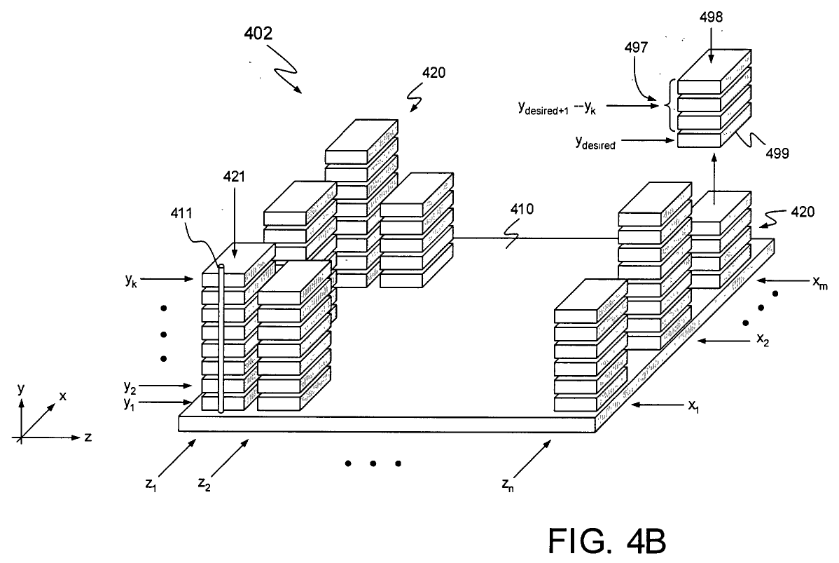

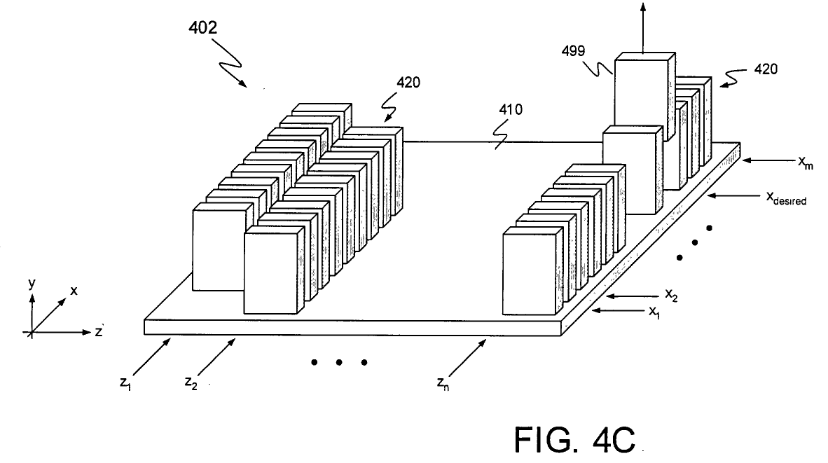

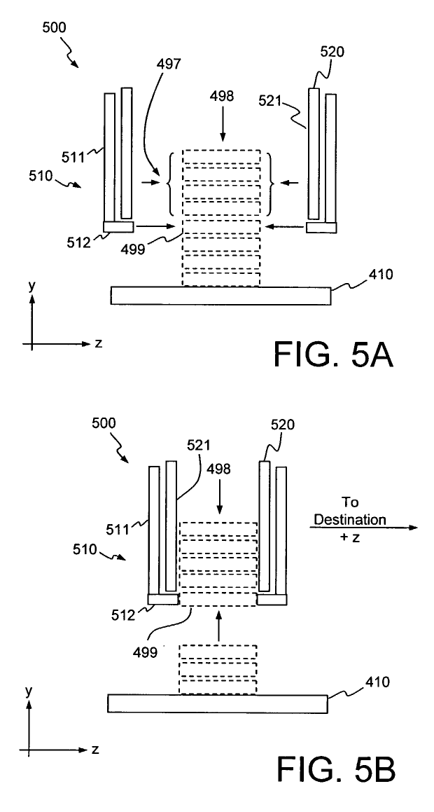

Various robotic or automated devices are known in the art for placing, retrieving, translating, rotating, and otherwise transporting sample carriers or sample carrier receivers. In this context, “sample carriers” may generally correspond to those described, for example, in non-provisional application Ser. No. 10/007,355, filed Nov. 7, 2001, entitled “SAMPLE CARRIER,” and non-provisional application Ser. No. 10/150,771, filed May 17, 2002, entitled “SAMPLE CARRIER SYSTEM.” Specifically, a sample carrier generally comprises a structure or medium operative to support a biological, non-biological, or chemical sample. Similarly, “sample carrier receivers” may generally correspond to standard or proprietary multi-well plates or equivalents thereof, such as those described in non-provisional application Ser. No. 10/150,770, filed May 17, 2002, entitled “SAMPLE CARRIER RECEIVER.” Specifically, a sample carrier receiver generally comprises structure configured and operative to receive and to maintain one or more sample carriers. For the sake of clarity and simplicity of discussion, the term “storage element” (designated by reference numeral 420 in FIGS. 4A-4C, for example) as used hereinafter generally encompasses both a sample carrier and a sample carrier receiver such as those described above and as set forth in detail in the related co-pending applications.

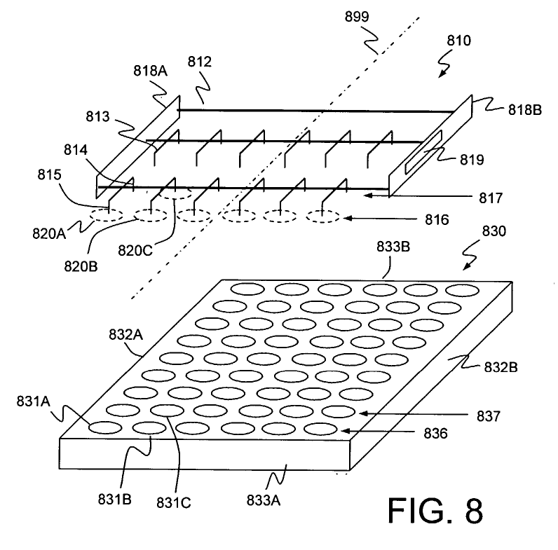

In particular, FIG. 8 is a simplified diagram illustrating one embodiment of a sample carrier and a sample carrier receiver disclosed in the co-pending applications. In the exemplary FIG. 8 embodiment, sample carrier 810 generally comprises a frame structure having a longitudinal axis represented by the dashed line 899. Carrier 810 may include one or more transverse (relative to longitudinal axis 899) members such as designated by reference numeral 812 and a plurality of sample site positioning members 813, each of which may accommodate one or more sample site members 814,815 in a predetermined spatial relationship. Though only three transverse members 812 are illustrated in FIG. 8, sample carrier 810 may be scaled to include any number of additional transverse members 812 as desired; alternatively, fewer than three transverse members 812 may be appropriate in certain situations.

A structural array, such as designated by reference numerals 820A-820C, configured and operative to maintain one or more samples, may be supported at each sample site member 814,815. It is noted that the depiction of structural arrays 820A-820C is representative only, and that certain physical components of structural arrays 820A-820C have been omitted from FIG. 8 for clarity; the particular characterization is not intended to be interpreted in any limiting sense.

As in the illustrated embodiment, sample carrier 810 may be constructed such that each structural array 820A-820C is supported in a predetermined spatial relationship relative to other structural arrays and relative to a respective specimen or sample container. By way of example, structural array 820A may be supported in a position to engage a respective well 831A in a sample carrier receiver 830 (embodied in a multi-well plate in FIG. 8), while structural array 820B may be supported to engage a different respective well 831B in sample carrier receiver 830.

In the exemplary embodiment depicted in FIG. 8, each structural array in a given row of sample sites on sample carrier 810, e.g. row 816, may be supported in a predetermined spatial relationship relative to a respective specimen or sample container in a corresponding row of wells in sample carrier receiver 830, i.e. row 836 in this example. Similarly, each structural array in row 817 (e.g. structural array 820C) may be supported to engage a respective well in row 837 of sample carrier receiver 830.

Sample carrier 810 may additionally include longitudinal frame elements 818A,818B which may support transverse members 812. In some embodiments, longitudinal elements 818A,818B may be constructed and operative to support a label, tag, decal, or other identifying indicia 819 which may be unique to sample carrier 810. As is generally known in the art, identifying indicia 819 may incorporate a two or three dimensional bar code, a serial number, or other alphanumeric or symbolic representation, for example, and may distinguish sample carrier 810 from other sample carriers maintained in an archive 330 such as described above. It will be appreciated that sample carrier receiver 830 may also include similar indicia.

Structural elements of sample carrier 810 may be constructed of any material with sufficient rigidity to support structural arrays 820A-820C in a desired predetermined spatial relationship, which may be influenced, for example, by the configuration or arrangement of respective sample containers such as an array of test tubes or the wells of sample carrier receiver 830. Additionally, longitudinal elements 818A,818B may be constructed and dimensioned to enable manipulation and transport of sample carrier 810 by robotics or other automated mechanisms as set forth in detail below; consequently, longitudinal elements 818A,818B may be constructed of appropriate material to withstand forces exerted by handling or gripping mechanisms. Accordingly, the structural elements of sample carrier 810 may be fabricated of polystyrene or various plastics or ceramics, for example, and may provide suitable stiffness without rendering sample carrier 810 unnecessarily heavy or cumbersome.

Similarly, sample carrier receiver 830 may be constructed using methods and materials commonly employed in fabrication of multi-well plates. It will be appreciated that sample carrier 810 and sample carrier receiver 830 may include various structural details not illustrated in FIG. 8. For purposes of the present disclosure: a sample carrier 810 is generally operative to support or to carry one or more samples, possibly in a two dimensional array as indicated in FIG. 8; and an embodiment of a sample carrier receiver 830 is generally operative to support or to contain one or more sample carriers 810 or parts thereof. In operation, sample carrier 810, either independently or in cooperation with sample carrier receiver 830, may maintain a plurality of samples in a predetermined spatial relationship, substantially in two dimensions.

As noted above, the term “storage element” as used in the present disclosure generally refers to sample carrier 810 in its entirety or in part, sample carrier receiver 830, or some combination or equivalents thereof operative to maintain, support, or otherwise to carry a plurality of samples in a particular spatial relationship. Accordingly, as contemplated herein, a storage element may be embodied in a sample carrier 810 or in a standard or proprietary multi-well plate such as that designated by reference numeral 830, or some combination of structural elements which facilitates the functionality noted above.

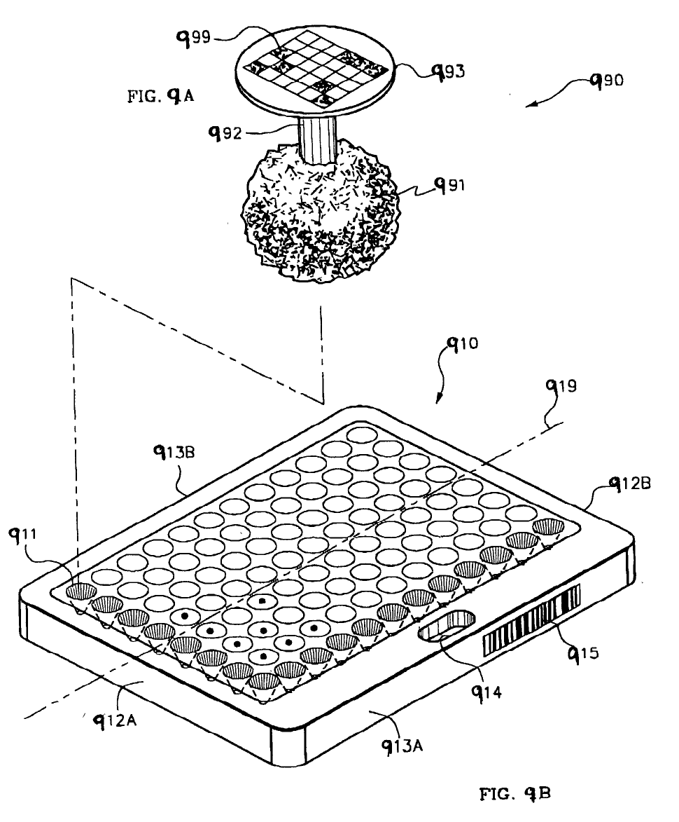

FIGS. 9A and 9B are simplified diagrams illustrating one embodiment of a sample carrier and one embodiment of a sample carrier receiver, respectively. As illustrated in FIG. 9A, a sample carrier 990 may generally comprise a sample node 991 operative to carry a discrete sample and a sample identifier 999 operative to provide information associated with the discrete sample carried at node 991.

As indicated in FIG. 9A, carrier 990 may include one or more physical structures, such as stem 992, configured and operative to support an identification and handling structure 993 to which identifier 999 may be attached. It is noted that the depiction of carrier 990 is representative only, and that, in particular, the characterization of stem 992 and identification structure 993 is not intended to be interpreted in any limiting sense. Specifically, the structural arrangement of the components of sample carrier 990 is susceptible of various modifications and alterations depending upon, among other things, the material from which the components are fabricated, the functionality of any automated handling mechanisms with which carrier 990 is intended to be used, and the structural characteristics of a sample carrier receiver with which carrier 990 is intended to be engaged as set forth in more detail below.

In that regard, the relative proportions, size, length, diameter, and other physical characteristics of stem 992 and identification structure 993 may be selected in accordance with the intended use of carrier 990. In some embodiments, for example, carrier 990 may be grasped and transported or otherwise manipulated by robotic gripping mechanisms, vacuum or magnetic chucks, or other automatic apparatus; accordingly, identification structure 993 and stem 992 may constructed of suitable material and be so dimensioned as to provide sufficient rigidity and structural integrity to withstand any external forces exerted by automatic handling or gripping devices on identification structure 993. Similarly, as set forth herein, carrier 990 may be configured and operative to engage a sample carrier receiver (such as represented by reference numeral 910 in FIG. 9B, for example) during use; accordingly, the length of stem 992 and the diameter and thickness of identification structure 993 may be suitably dimensioned to facilitate interoperation of carrier 990 with such a receiver.

Structural elements of carrier 990 may be constructed of any material with sufficient rigidity to enable the manipulation and transport of carrier 990 by robotics or other automated mechanisms. It will be appreciated that the structural elements of carrier 990, including sample node 991, may be formed or molded as an integrated unit, for example; in some embodiments, carrier 990 may be fabricated using injection molding techniques generally known in the art, for instance. Alternatively, some or all of the components may be fabricated individually and subsequently attached, adhered, fused, joined, or otherwise integrated to form a unified structure for carrier 990. Sample node 991, stem 992, and identification structure 993 may be fabricated of polystyrene or various plastics, for example, such that the overall structure of carrier 990 is afforded suitable stiffness without rendering carrier 990 unnecessarily heavy or cumbersome. It will be appreciated that various fabrication techniques generally known in the art may be used to construct carrier 990 and the various components illustrated in FIG. 9A. The present disclosure is not intended to be limited to any particular materials or construction methods employed with respect to fabrication of carrier 990.

As noted generally above, the exemplary embodiment of carrier 990 generally comprises sample node 991 operative to carry a discrete sample and identifier 999 operative to provide information associated with the discrete sample carried at node 991. In the illustrated arrangement, identifier 999 is co-located with the sample it identifies.

The term “co-located” in this context generally refers to the location of both the sample and identification or other information associated with the sample. For instance, identifier 999 may be attached, adhered, fused, coupled, or otherwise connected to node 991 as described above, for example, via suitable components such as stem 992 and identification structure 993; alternatively, identifier 999 may be integral with or incorporated into the structure of node 991 itself such that supporting or attaching structures may be omitted.

In that regard, identifier 999 and node 991 may be “permanently” co-located such as through physical attachment or through integration of identifier 999 with node 991. Accordingly, unique identification information and other data may be co-located with the sample carried at node 991 throughout the useful life of sample carrier 990 (i.e. until sample material is removed or extracted from node 991 for experimentation or other use).

Permanently co-locating node 991 and identifier 999 substantially as set forth herein may ensure that information associated with a particular discrete sample is always available at the location of that sample. Accordingly, handling errors (arising for example, due to misplacement of node 991) may be minimized or eliminated, since the sample at node 991 may be identified by reference to identifier 999, and since identifier 999 is integrated with or connected to node 991.

It will be appreciated that sample node 991 may be substantially spherical as represented in FIG. 9A; alternatively, node 991 may be formed in any of numerous shapes and sizes. Those of skill in the art will appreciate that several polygons, polyhedrons, pyramidal or triangular shapes, disks, or oblong embodiments are contemplated and may be selected based upon various factors such as the desired node size and density, the saturation limit of the material used for sample node 991, the accuracy and precision of the device used to manipulate sample carrier 990, and the like. The present disclosure is not intended to be limited by the shape, size, or dimensional characteristics of sample node 991.

Sample node 991 may bind sample material directly or indirectly. In that regard, an exemplary node 991 may generally comprise, or be constructed entirely of, a sample support medium. In some embodiments, for example, node 991 may simply be coated with a selected sample support medium such that node 991 binds a sample indirectly; alternatively, the entire structure of node 991 may be fabricated of a sample support medium (i.e. sample support medium may constitute the structure of node 991) to bind the sample directly. In accordance with one aspect of the present invention, sample support media for use at sample node 991 may be embodied in paper or cellulose, polymers such as polystyrene or chitosan, plastic, ceramic, or other suitable support material constructed and operative to serve as a long-term storage mechanism for biological or other sample material. Specimen material in solid, liquid, or gaseous form may be brought into contact with the sample support medium and stored as a sample at discrete sample node 991.

In some embodiments, for example, such a sample support medium may maintain samples of biopolymers, including polynucleotides such as ribonucleic acid (RNA) and deoxyribonucleic acid (DNA) as well as proteins, or non-biological samples, including fluorocarbons or chlorofluorocarbons (CFCs), environmental pollutants, and synthetic chemical compounds. As set forth in the related applications noted above, various filter paper substrate embodiments are currently known in the art; for example, U.S. Pat. No. 6,294,203 discloses a dry solid medium for storage of sample material which may be suitable for incorporation into sample carrier 990. The disclosure of this United States Patent is hereby incorporated by reference in its entirety.

The present disclosure is not intended to be limited with respect to specific sample support media employed at node 991. Accordingly, a support medium suitable for implementation at sample node 991 may generally comprise any appropriate material known in the art or developed and operative in accordance with known principles, and may be selected in accordance with binding properties as a function of the type of sample to be carried and maintained.

An appropriate sample support medium may be solid or porous, for example, depending, in part, upon the type of specimen to be stored as a sample at node 991. Additionally or alternatively, sample support medium may be treated with one or more chemical compounds or derivatized, for instance, to manipulate various binding properties prior to contact with a specimen. Positive or negative electrical charges, chemical compositions, binding characteristics, antibodies, lectins, porosity, and other operational factors for sample node 991 may be selected in accordance with the type of sample support medium implemented and the type or nature of any processes performed thereon.

Biological, non-biological, and chemical samples may be stored in a controlled environment. In that regard, humidity, temperature, and other environmental factors may be controlled in a fireproof vault or other structure employed as an archive. In some embodiments, environmental conditions may be selectively altered depending, for instance, upon the nature of the samples, the composition of the sample support medium employed at sample node 991, or both, to preserve longevity of the samples for decades. In a biopolymer (such as a polynucleotide) archival embodiment, for example, the sample support medium may include a chemically treated surface or structure, serving to lyse particular specimen cells and to immobilize the polynucleotide structure to the sample support medium or substrate at discrete sample node 991. Additionally or alternatively, preservatives may be applied, embedded, impregnated, or otherwise incorporated onto or into the sample support medium; such preservatives may ensure the stability and fidelity of the polynucleotide structure for tens of years. Sample node 991, which may be characterized by a discrete pellet or sphere as represented in FIG. 9A, may be selectively deposited in a particular well disposed in a multi-well plate as represented in FIG. 9B; samples deposited in particular wells may, in turn, be selected for subsequent processing (e.g. such as with polymerase chain reaction (PCR) assays, and the like).

Cross contamination may be virtually eliminated by storing a sample on node 991. In some instances, mechanical contact involving a mechanical sample removal device may be entirely eliminated during retrieval, extraction, purification, packaging, and shipping. Moreover, since carrier 990 or handling and identification structure 993 may be amenable to manipulation by standard robotics, an entire archive facility may be easily automated to achieve high throughput rates (for example, greater than one hundred samples per day).

Polynucleotides such as DNA or RNA archived and retrieved using sample carrier 990 as set forth above may be well suited for large-scale genetic analysis, and may yield samples which are superior (relative to conventional liquid phase or cryogenic technologies) for pharmacogenetics or other types of genetic discovery analyses. Specifically, implementation of sample node 991 may automatically standardize the quantity and quality of polynucleotide storage due to the inherent loading properties of the sample support medium and any embedded chemicals serving to diminish PCR inhibitors; accordingly, the requirements and complexities of quantification procedures following purification in conventional polynucleotide extraction may be simplified, reduced, or eliminated entirely. Additionally, archive samples stored in solid state form arc not continuously degraded as are frozen samples during repeated freezing and thawing cycles as is common in cryogenic systems.

In operation, identifier 999 may generally maintain or provide information associated with the discrete sample carried at node 991. In some embodiments, identifier 999 may enable access to such information, maintaining or providing a unique code, serial number, or other identifying indicia associated with the sample; in such embodiments, a database or other record store may be interrogated or queried for information associated with the sample using the code or signal displayed or provided by identifier 999.

In this context, therefore, and to simplify further discussion, it will be appreciated that the functionality of identifier 999 referred to as “providing” information associated with a sample generally encompasses, without limitation: maintaining or storing such information, in whole or in part, at identifier 999; communicating, transmitting, or otherwise conveying such information, in whole or in part, from identifier 999; and reflecting, signaling, transmitting, or otherwise communicating a unique code, signal, data stream, or other indicator operative to identify the sample and to enable access to such information.

In the FIG. 9A embodiment, for instance, identifier 999 generally comprises identifying indicia by which a sample carried at node 991 may be uniquely identified. In that regard, identifier 999 may comprise a two-dimensional bar code having light and dark areas such as indicated in FIG. 9A; similarly, identifier 999 may include a one-dimensional bar code having parallel lines of varying width and separation. Additionally or alternatively, identifier 999 may comprise a serial number, lot number, alpha-numeric code, or other symbolic representation suitable to identify or to distinguish sample material carried at node 991. Such bar codes or other identifying indicia may be scanned by any of various machine vision or other optical sensors or reading devices generally known in the art. In these embodiments, identifier 999 may maintain or provide a unique sample identification encoded in the bar code or identifying indicia; accordingly, information associated with the sample at node 991 may be obtained or accessed using the unique identifying encoded in the indicia.

In some embodiments, for example, optical reading equipment may generally comprise machine vision technology, video cameras, or other optical sensors which are capable of identifying or locating the elements represented in the bar code or other indicia of identifier 999 using instruments or receptors which are sensitive to various portions of the electromagnetic spectrum. In this embodiment, optical information (from the visible portion of the spectrum) or other electromagnetic information (such as microwave or infrared frequencies, for example) may be used to ascertain the identity, nature, and general constitution of the co-located sample carried at node 991.

Sample identification and other information maintained and provided by identifier 999 may generally include, but is not limited to: a distinct identifier code or other indicia enabling accurate identification and tracking of the sample; the nature or type of sample (e.g. blood, DNA, RNA, protein, environmental particles, or pollutants); the source or origin of the sample (e.g. age, gender, and medical history of a person, or the location and circumstances under which an environmental sample was collected); the time and date the sample was collected or archived; and the like. Data records or other structures representative of this information may be encoded in identifier 999 itself, for example, or may be maintained in a database or other data storage structure or facility.

In some implementations, sample carrier 990 may be designed or configured to engage a sample container such as a well in a standard or modified multi-well plate. When carrier 990 is engaged with such a container or sample carrier receiver, node 991 may be brought into contact with specimen material in the well; alternatively, carrier 990 may engage a clean or unused well (i.e. one containing no specimen material or traces of contaminants) such that the sample material at node 991 may be stored and cross-contamination between samples carried at individual sample nodes may be prevented.

As noted above, FIG. 9B is a simplified diagram illustrating one embodiment of a sample carrier receiver. In the illustrated embodiment, sample carrier receiver 910 generally comprises a plurality of sample containers or wells 911 arranged in a predetermined orientation relative to a longitudinal axis 919. Each well 911 may be configured and operative to receive a sample carrier 990, and more particularly, a sample node 991 substantially as described above.

It will be appreciated by those of skill in the art that the FIG. 9B embodiment of receiver 910 is illustrated by way of example only, and not by way of limitation. Various shapes of receiver 910 and configurations of wells 911 are within the scope and contemplation of the present disclosure. While a rectangular configuration is illustrated and described herein, for example, receiver 910 may alternatively be generally circular, generally square, or polygonal in plan, depending for example, upon the requirements or configuration of the laboratory or archive facility in which receiver 910 is utilized.

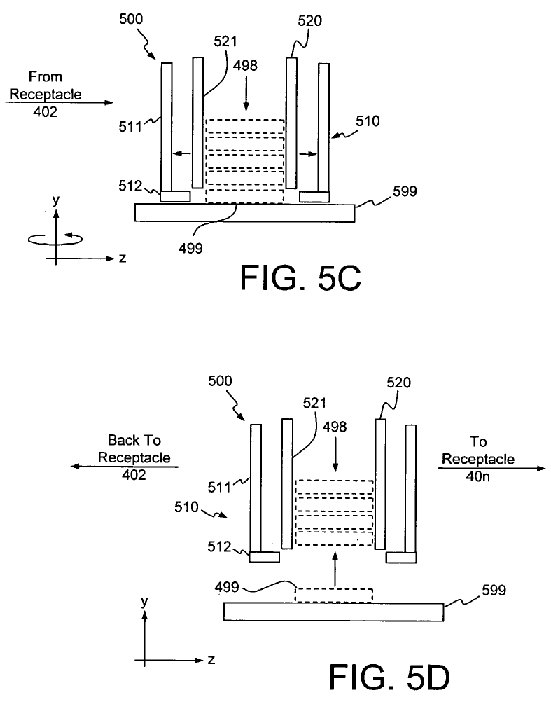

In an exemplary rectangular embodiment, receiver 910 generally comprises longitudinal sides 913A, 913B and transverse sides 912A, 912B. Those of skill in the art will appreciate that scientific sample storage and experimentation systems may employ robotic mechanisms for grasping, translating, or otherwise manipulating multi-well plates in a laboratory or sample archive facility. Accordingly, sides 912A-B, 913A-B may be shaped and dimensioned such that suitable gripping or sample handling mechanisms may engage receiver 910 for appropriate or desired manipulation as set forth in more detail below with reference to FIGS. 5A-5D.

In that regard, receiver 910 may generally be fabricated of any suitable material providing sufficient rigidity and strength to withstand forces exerted by such automated or robotic systems. It may also be desirable to construct receiver 910 of material which will not contaminate any sample or specimen material contained in wells 911. Various plastics, ceramics, polystyrenes, polymeric and other materials generally known in the art for constructing multi-well plates may be suitable for receiver 910, wells 911, and other components of receiver 910 described below.

Receiver 910 may be fabricated as a single unit, for example, or may generally comprise two or more pieces fabricated individually and subsequently joined, adhered, or otherwise connected.

Additionally, receiver 910 may be constructed and operative to support a label, tag, decal, or other identifying indicia 915 which may be unique to receiver 910. As is generally known in the art, identifying indicia 915 may incorporate a bar code (e.g. either one-dimensional as illustrated in FIG. 9B, or two-dimensional as illustrated in FIG. 9A), a serial number, or other alpha-numeric or symbolic representation, for example, and may distinguish receiver 910 from other sample carrier receivers maintained in an archive or laboratory facility. In such an embodiment, indicia 915 may be placed or oriented on a selected side 912A-B, 913A-B such that indicia 915 are not obscured or marred by robotics or other mechanisms designed to handle receiver 910.

With reference now to both FIGS. 9A and 9B, it will be readily apparent that carrier 990 and receiver 910 may be constructed and dimensioned such that sample node 991 is supported in a predetermined spatial relationship relative to specimen material contained in a respective container such as well 911. By way of example, sample node 991 may be placed in a position to contact specimen material in well 911. In accordance with conventional multi-well plate implementations, it is necessary to insert or to deposit specimen material into well 911 through the opening which defines the sample container (i.e. well 911) itself. In other words, it is not possible to introduce specimen material into well 911 (i.e. “load” well 911 with specimen) from the bottom or lower extremity of well 911.

As set forth in more detail in the related co-pending non-provisional application Ser. No. 10/150,770, filed May 17, 2002, entitled “SAMPLE CARRIER RECEIVER,” receiver 910 may additionally comprise a duct or manifold 914 configured and operative to receive specimen material, cleaning agents, or other solutions; in accordance with some embodiments, specimen material or other liquids may be distributed from manifold 914 to every well 911 (or to a selected plurality of wells) in receiver 910 through one or more conduits (not shown in FIG. 9B).

Accordingly, each well 911 or specimen container in receiver 910 may generally comprise a first opening configured and operative to receive a sample node (such as node 991 in FIG. 9A) and a second opening, in communication with a conduit, for example, configured and operative to receive specimen material, rinsing solutions, or other liquids introduced at and distributed by manifold 914. In such an arrangement, sophisticated robotics and alignment mechanisms may be omitted from the well loading process, since a single source of specimen material injected or otherwise introduced at manifold 914 may provide sufficient material to load each well 911 in receiver 910 through a respective second opening in communication with manifold 914.

Those of skill in the art will appreciate that receiver 910 may include or be configured to accommodate a lid or cover (not shown) such as generally used in conjunction with multi-well plates. In some embodiments, indicia 915 may be placed or oriented such that a cover, when operatively engaged with receiver 910, does not obscure indicia 915; alternatively, a cover for use with receiver 910 may be modified or specifically constructed so as not to obscure indicia 915.

As noted above, the term “storage element” as used in the present disclosure generally refers to sample carrier 990 in its entirety or in part, sample carrier receiver 910, or some combination or equivalents thereof operative to maintain, support, or otherwise to carry a plurality of samples in a particular spatial relationship. Accordingly, as contemplated herein, a storage element may be embodied in a sample carrier receiver 910 or other standard or proprietary multi-well plate loaded with a respective sample carrier 990 disposed in a respective well 911.

Returning now to FIG. 3, in operation, robotics 331 may comprise automatically controlled arms, gripping devices, or handling apparatus which may be translated or otherwise manipulated in three dimensions; in some embodiments, robotics 331 may include one or more gripping apparatus such as described below with reference to FIGS. 5A-5D. Such robotics 331 may generally be configured and operative to retrieve selected storage elements from sample storage 332 and to manipulate retrieved items in accordance with data and instructions received from processor 321 at controller 320. Those of skill in the art will appreciate that robotics 331 may comprise computer hardware and software (not shown) sufficient to enable the bi-directional data communication illustrated in FIG. 3; additionally, some embodiments of robotics 331 may include powerful processors, for example, coupled to machine vision or other identification devices such as bar code readers or optical sensors as described above.

In addition to placing, locating, identifying, retrieving, and manipulating storage elements stored or archived at sample storage 332, robotics 331 may further be operative to utilize equipment 333 required for conducting desired operations on or with respect to samples. As noted above, these operations may include washing, purification, alteration, testing or experimental analysis, replacing, packaging, shipping, and the like.

In that regard, robotics 331 may be embodied in, for example: sample storage devices or means operative to place storage elements into or onto receptacles at sample storage 332; sample location devices, which may employ optical sensors or machine vision technology as described above, for locating particular samples or storage elements from among the plurality archived at sample storage 332; sample retrieval devices or means for retrieving selected storage elements from sample storage 332; and sample node removal devices (such as described in the related co-pending applications), which also may employ optical sensors. Additionally or alternatively, a technician employed at archive facility 360 may place storage elements into receptacles, identify, locate, and retrieve selected samples or storage elements, and manipulate samples manually.

Data storage medium 334 may be embodied in the types of hardware described above, and may maintain data records related to the samples deposited in sample storage 332, operational parameters of robotics 331 and other mechanized or automated devices, and the availability and variety of equipment 333. For example, storage medium 334 may maintain data records associated with each sample in sample storage 332, including, but not limited to: the nature or type of sample (e.g. blood, DNA, protein, environmental particles or pollutants); the source or origin of the sample; the date the sample was archived; the particular location within sample storage 332 of one or more storage elements containing the sample; the number of times the sample has been retrieved; the tests or experiments conducted; and the like. Similarly, storage medium 334 may include data records related to the available supply of multi-well plates or other sample vessels at archive 330, the maintenance schedule for various robotic equipment, and so forth. It will be appreciated that data records and other information maintained at storage medium 334 may be transmitted to storage medium 315 at coordinator 310; such transmission may occur periodically, for example, at predetermined time intervals, or responsive to specific requests or interrogations from processor 311.

The nature and variety of robotics 331 and equipment 333 employed at archive 330 may generally be influenced by the manner and form in which samples are maintained and stored in sample storage 332. For example, where samples or storage elements are stored in conjunction with an identifying bar code label, robotics 331 may comprise a bar code reader. Since, as noted briefly above, certain automated or other robotic systems are known for retrieving, handling, and replacing different types of laboratory containers and storage elements, sample storage 332 may be constructed and configured for use with existing machines. As set forth in detail below with reference to FIGS. 4A-5D, proprietary robotics systems and gripping apparatus may be employed in conjunction with a high-density sample storage arrangement (i.e. storage strategy) and an efficient placement and retrieval technique.

In that regard, sample storage 332 may generally comprise a one or more receptacles, each of which may be configured to receive or to support a plurality of storage elements as set forth in more detail below. Such receptacles may be implemented as drawers, trays, shelves, bins, or racks, for example. In some embodiments, sample storage 332 may be an environmentally controlled vault or other structure designed to maintain samples at a constant or optimum humidity and temperature; environmental parameters may be selected in accordance with the type and the state of the samples. Alternatively, the entire archive 330 may be contained within a single environmentally controlled vault.

FIG. 4A is a simplified perspective diagram of one embodiment of a sample storage component configured and operative for use in an archive facility, and FIG. 4B is a simplified perspective diagram illustrating one embodiment of a receptacle configured and operative for use in conjunction with a sample storage component. As represented in FIG. 4A, sample storage component 332 corresponds to that described above with reference to FIG. 3, and generally comprises a plurality of receptacles 401-40n arranged in a desired three dimensional geometry or configuration. It is noted that the present disclosure is not intended to be limited by the particular arrangement illustrated in FIG. 4A; those of skill in the art will appreciate that sample storage 332 may further comprise any number of additional receptacles 401-40n in any of the x, y, or z directions without inventive faculty.

As noted above, each receptacle 401-40n may be embodied in a movable drawer, tray, shelf, rack, or equivalent structure suitable for supporting or containing one or more storage elements (reference numeral 420). As indicated in FIG. 4A, receptacles 401-40n may be movable relative to each other, enabling access to storage elements 420 contained in or disposed on each respective receptacle 401-40n; such access may be via manual or robotic handling mechanisms (not shown), depending upon, among other things, the sophistication of the various hardware and software components of the archive facility in which sample storage 332 is implemented.

For example, receptacles 401-40n may be operatively engaged with rollers, bearings, rails, tracks, and the like, as is generally known in the art. In such an embodiment, receptacle 402 may be translated in the x direction as indicated in FIG. 4A, allowing placement, retrieval, or other manipulation of one or more storage elements 420 as set forth in more detail below.

In accordance with the FIG. 4B embodiment, receptacle 402 generally comprises a support surface 410 operative to carry, support, or otherwise to engage a plurality of storage elements 420 in a two dimensional configuration comprising one or more stacks (such as indicated by reference numeral 421) of storage elements 420. Accordingly, storage elements 420 may be arranged in a three dimensional configuration substantially as shown; as noted above with respect to receptacles 401-40n, the specific arrangement, configuration, number, or spatial interrelation of stacks 421 or storage elements 420 may vary in accordance with system requirements, capabilities and limitations of robotic handling apparatus or systems, the size and shape of storage elements 420 or receptacle 402, and so forth. The rectangular embodiment of FIG. 4B is shown and described for simplicity, by way of example only, and not by way of limitation.

In some embodiments, a desired number, k, storage elements 420 may be stacked in the y direction. It will be appreciated that each stack 421 in any given receptacle 402 may maintain a different number of storage elements 420. Each storage element 420 in a given stack 421 may be secured or maintained in place, for example, with a series of orienting posts or integral interlocking features associated with each storage element 420. For example, each storage element 420 may be provided with one or more alignment prongs or protuberances designed and operative to engage one or more corresponding slots, grooves, or notches in neighboring storage elements 420 when one or more storage elements 420 are stacked as illustrated in FIGS. 4A-5D. Various methods of providing interlocking structural features operative to stabilize items when stacked are generally known in the art; in some embodiments, for example, each storage element 420 may comprise a “skirt” or flange operative to engage the top surface of an underlying storage element 420. Specifically, such interlocking structural features generally prevent movement of one storage element 420 in a given stack 421 relative to the others in the same stack 421; movement in the y direction allows interlocking structural features to disengage, enabling subsequent movement of storage element 420 in the x or z directions.

Additionally or alternatively, one or more guide posts, rails, or similar stabilizing structures extending in the y direction from support surface 410 may facilitate stabilization of each stack 421 and prevent movement of storage elements 420 relative to each other or relative to support surface 410. In some embodiments, each storage element 420 may be constructed and operative to engage such a stabilizing structure. In the FIG. 4B embodiment, for example, a stabilizing structure 411 is illustrated as a post extending from support surface 410. In operation, storage elements 420 may include a notch or depression dimensioned to engage or to abut stabilizing structure 411 such that relative movement (in either the x or z direction) of storage elements 420 in stack 421 is prevented.

In the foregoing or an equivalent manner, the k storage elements 420 in any given stack 421 may be prevented from slipping, i.e. relative movement in either the x or z direction may be prevented. Additionally, in such an embodiment, one or more edges (oriented along the x or z axes) of the stacked storage elements 420 may be accessible by appropriate handling mechanisms.

A plurality of stacks 421 may be stored or maintained in receptacle 402, and may generally be arranged on support surface 410 as a two dimensional configuration with a maximum dimension of n stacks (in the z direction) by m stacks (in the x direction), as depicted in FIGS. 4A and 4B. Spacing between the various stacks on support surface 410 may generally be a function of the size and pattern of any stabilizing structure 411 (embodied as a post or guide rail, for example) extending in the y direction from support surface 410, and the clearance required for tooling or handling apparatus to select and to engage a single stack 421 in receptacle 402. In the exemplary embodiment, therefore, a receptacle 402 accommodating a three dimensional configuration of stacked storage elements 420 has a maximum capacity of n X m X k storage elements 420.

In operation, receptacle 402 may be manipulated (e.g. such as indicated in FIG. 4A), in such a manner as to allow access to each storage element 420 in the configuration arranged on support surface 410. In particular, each storage element 420 in each stack 421 may be individually addressable in terms of x, y, and z coordinates, for example, enabling easy identification and direct access to every addressable storage element 420. In some embodiments, storage elements 420 may be accessed by a robotic arm or other automated handling apparatus for placement, retrieval, or manipulation substantially as set forth below.

One or more handling apparatus, robotic arms, or other mechanical devices may retrieve any storage element 420 from any given stack 421 in receptacle 402; in FIG. 4B, for example, a target storage element 499 is illustrated as positioned in a stack 498 (at location x=xₘ, z=zₙ) at a desired y coordinate (y=y_{desired}). In the exemplary embodiment, the handling apparatus or robot arm may extract target storage element 499 from stack 498 substantially as depicted in detail in FIGS. 5A-5D. First, the handling apparatus may grasp and lift all storage elements from the top (i.e. y=yₖ) of stack 498 down to and including target storage element 499 at y=y_{desired}. Both storage element 499 and the upper portion 497 (i.e. at y=y_{desired+1} through yₖ) of stack 498 may be manipulated as a unit. In accordance with such an embodiment, target storage element 499 as well as storage elements in upper portion 497 of stack 498 may be collectively translated to a desired position in an archive facility; storage element 499 may then be placed in an appropriate location. At a specified, predetermined, or dynamically selected position, for example, the handling apparatus may release target storage element 499 while retaining the remaining storage elements in upper portion 497 of stack 498.

The remaining upper storage elements corresponding to y=y_{desired+1} through yₖ may be returned to the configuration at receptacle 402, either at the original stack location (x=xₘ, z=zₙ) or at some other more convenient location within the available n X m X k volume of receptacle 402. In the former case, for example, the resulting stack at x=xₘ, z=zₙ may only contain k−1 storage elements 420 following this sequence. Alternatively, the remaining upper storage elements may be repositioned at another receptacle (401 or 403-40n in FIG. 4A), for example.

The foregoing storage arrangement and retrieval technique generally provide space-efficient, high-density storage in which individually addressable and directly accessible storage elements 420 may occupy most of the available volume in a sample storage component 332 of a storage facility 330. A suitable data model for representing the respective locations (i.e. individual addresses in three dimensional space) of each storage element 420 in sample storage 332, however, must be more complex than typical data models employed in conjunction with conventional systems. For example, within a given stack 498, removal and insertion operations affect not only the position of the target storage element 499, but also all of those storage elements above it, i.e. those in locations y=y_{desired+1} through yₖ.

An appropriate data model for the FIG. 4A sample storage component 332 may represent each possible storage, location, including unoccupied potential locations, as one or more records in a table, database, or other suitable data structure, for instance, which may be maintained at data storage medium 334 as described above with reference to FIG. 3. In some embodiments, such a table or database may include one record for each location, where each record may include, inter alia, the following fields:

receptacle identification (e.g. 402);

row identification (i.e. x coordinate);

column identification (i.e. z coordinate);

stack position identification (i.e. y coordinate);

storage element identification (e.g. 499); and

state (e.g. occupied, empty, reserved).

The receptacle, row, and column fields may, in combination, specify or uniquely identify a particular stack (such as 498 in FIG. 4B) within the entirety of the volume of sample storage 332. The stack position field may enable identification of the desired height, or y coordinate, of a selected storage element within the targeted stack. Additionally or alternatively, the storage element identification field, if present, may indicate or uniquely identify a particular storage element in a given storage location. Further, the state field may indicate whether a particular location is empty or full.

Accordingly, each storage element 420 may be individually addressable in three dimensional space using appropriate references to receptacle identification and coordinate axes. In some storage strategies such as described below in detail with reference to FIG. 4C, for example, each storage element 420 may be individually addressable in terms of two dimensional coordinates within a given receptacle. In the FIG. 4B storage strategy embodiment, three coordinates (in addition to a proper receptacle identification) may be required for accurate addressing of each individual storage element 420.

Those of skill in the art will appreciate that some embodiments may dynamically cross-reference the storage element identification field with receptacle identification and x, y, and z coordinate information; accordingly, the storage element identification field may be sufficient to enable a robotic device to ascertain the address of any given storage element in three dimensional space and to retrieve that particular storage element. The storage element identification field may correspond to, or work in conjunction with, the bar code identification tags described in the related applications, for example, and may uniquely identify each storage element, as well as the samples contained therein.

FIGS. 5A through 5D are simplified block diagrams illustrating elevation views of one embodiment of a storage element handling apparatus in operation. In the exemplary embodiment, handling apparatus 500 may comprise a storage element gripper 510 operative to engage a target storage element 499 (i.e. at y=y_{desired} as indicated in FIG. 4B) and a stack gripper 520 operative to engage the upper portion 497 (i.e. y=y_{desired+1} through yₖ) of a stack 498 arranged at an addressable location on support surface 410 as set forth in detail above.

In the illustrated embodiment, storage element gripper 510 may comprise a vertical structure 511 coupled to a grip 512; storage element gripper 510 may be appropriately dimensioned such that vertical structure 511 supports grip 512 beyond stack gripper 520 as shown. As indicated by the arrows in FIG. 5A, both storage element gripper 510 and stack gripper 520 may be selectively translated in the z direction, for example, enabling grip 512 and a proximal surface 521 of stack gripper 520 to engage target storage element 499 and upper portion 497 of stack 498, respectively.

It is noted that handling apparatus 500, and in particular, storage element gripper 510 and stack gripper 520, are depicted in representative form only, and that certain structural components, interconnections, and functional mechanisms have been omitted from FIGS. 5A-5D for clarity. Those of skill in the art will appreciate that the general constitution and physical configuration of handling apparatus 500 are susceptible of various forms, and that numerous alternative implementations may be practical. For example, relative motion between storage element gripper 510 and stack gripper 520 may be provided via rack and pinion systems, gearing mechanisms, worm gears, hinges, and the like. Alternatively, since storage elements 420 are generally stacked and supported in such a manner (e.g. using interlocking structural features) as to prevent relative slipping in the x or z directions as set forth above, stack gripper 520 may be omitted in some simplified embodiments. Additionally, appropriate hinges, gimbals, or other mechanisms enabling rotation or revolution about selected axes, though not shown, are also contemplated. The present disclosure is not intended to be limited to any particular construction, structural arrangement, or combination of mechanical components implemented in conjunction with handling apparatus 500.

As indicated in FIG. 5B, when grip 512 engages target storage element 499 and proximal surface 521 engages upper portion 497 of stack 498, handling apparatus 500 may be translated in the y direction a sufficient distance to clear any neighboring stacks 421, stabilizing structures 411, or other structural components associated with receptacle 402. Subsequent translation in either the x or z direction may occur as required, for example, under control of signals transmitted from or through mechanical interface 323 as described above.

As depicted in FIG. 5C, handling apparatus 500 may be translated to any selected location within sample storage 332 or archive 330, for example, and may subsequently place target storage element 499 in a desired position on a selected surface 599. In that regard, it is noted that handling apparatus 500 may additionally be rotated about one or more coordinate axes, such as the y axis, in order to place target storage element 499 in a desired orientation as well as in a desired position on surface 599. As represented by the arrows in FIG. 5C, storage element gripper 510 may be independently movable relative to stack gripper 520, such that target storage element 499 may be released independently of upper portion 497 of stack 498. Accordingly, as shown in FIG. 5D, upper portion 497 of stack 498 may be returned to receptacle 402, for instance, or otherwise relocated relative to target storage element 499 without requiring reorientation of storage element gripper 510 and stack gripper 520.

As noted above, handling apparatus 500 may be simplified in some embodiments, for example, omitting stack gripper 520. The sequence of events depicted in FIGS. 5A-5D may be executed without gripping upper portion 497 of stack 498, since engaging target storage element 499 with grip 512 enables simultaneous manipulation of every component having a y coordinate greater than that of target storage element 499 in stack 498. Where such a simplified single element apparatus is employed, grip 512 may be repositioned for some functions. For example, after appropriate placement of target storage element 499 as in FIG. 5C, grip 512 may disengage target storage element 499 and subsequently engage the adjacent storage element 420 (i.e. in the y=y_{desired+1} position); accordingly, upper portion 497 of stack 498 may be manipulated with a single storage element gripper 510 rather than with proximal surface 521 of stack gripper 520 as illustrated in FIG. 5D, for example.

In an alternative embodiment, storage elements 420 or stacks may be stored or archived “on end” in receptacles 401-40n. In the embodiment illustrated in FIGS. 4A and 4B, for example, “on end” generally refers to a rotation through a full 90 degrees on either the x axis, the z axis, or both, such that storage elements 420 are not stacked on support 410. It will be appreciated that this alternative storage methodology may simultaneously provide high storage density as well as rapid and efficient access to storage elements.

FIG. 4C is a simplified perspective diagram illustrating such an alternative embodiment of a receptacle configured and operative for use in conjunction with a sample storage component. As noted above, storage elements 420 may be stored on end in receptacle 402; in the exemplary FIG. 4C embodiment, storage elements 420 have been rotated 90 degrees on the z axis relative to their orientation in FIGS. 4A and 4B. Additionally or alternatively, storage elements 420 may be rotated on the x axis, depending upon, for example, the size and shape of receptacle 402, the size, general operability and clearance requirements of handling mechanisms, and the like.

It will be appreciated that orienting storage elements 420 on end as illustrated in FIG. 4C may introduce additional requirements related to preventing loss of sample material. Accordingly, each storage element 420 in the FIG. 4C embodiment may be sealed, for example, or may contain only sample material that will stay in place when its respective storage element 420 is rotated.

The FIG. 4C strategy of archival and retrieval may provide superior storage density for a given storage element pitch in a particular receptacle. In addition, since storage elements 420 are not arranged in stacks, every storage element 420 may be retrieved directly (i.e. any given storage address or location may be accessed without disturbing a storage element 420 present at any other address), allowing a simple data model. For example, a target storage element 499 may be simply addressed using only x and z coordinates; as depicted in FIG. 4C, target storage element 499 is located at x=x_{desired} and z=zₙ. These two coordinates, along with a receptacle identification field, may be sufficient to locate any given storage element 420 within the entire three dimensional space encompassed by sample storage component 332.

As with the embodiment illustrated in FIGS. 4A and 4B, at least one edge (oriented along the x or z axes in FIG. 4C) of every storage element 420 is exposed in an arrangement such as depicted in FIG. 4C; accordingly, an identifying label or other indicia (such as represented by reference numeral 915 in FIG. 9B, for example) may be scanned by manual or robotic handling mechanisms. It will be appreciated that handling apparatus 500 may include appropriate hinges, gimbals, or other mechanisms enabling rotation or revolution about selected axes as described above; in this embodiment, a single handling apparatus 500 may be suitable for different storage strategies (exemplified in FIGS. 4B and 4C, for example) employed at different receptacles.

Returning to the storage strategy embodiment illustrated in FIGS. 4A and 4B, those of skill in the art will appreciate that the data model described above may benefit from modifications to accommodate storage elements 420 of varying depth (in the y dimension). Where every storage element 420 in a particular stack 498 is not of uniform depth, for example, the absolute value of the y coordinate (i.e. height above support surface 410, for example) for a target storage element 499 may not be calculated precisely unless the depth of each storage element 420 is known and recorded for reference. Accordingly, a database record associated with each storage element 420 in the system may include an additional field representing storage element depth.

In such an embodiment, a storage and retrieval system and method may access appropriate data records and compute the y coordinate of target storage element 499 by summing the values in the storage element depth field for every storage element below (i.e. at y=y₁ through y_{desired-1}) target storage element 499 in stack 498; in this instance, while the y coordinate representing the height above support surface 410 of target storage element 499 may be calculated precisely, information regarding upper portion 497 of stack 498 may be deficient, complicating storage element handling operations. Alternatively, storage element depth fields may be summed for every storage element above (i.e. at y=y_{desired+1} through yₖ) target storage element 499. In this instance, y coordinate information derived from the top (y=yₖ) of stack 498 down to target storage element 499 may facilitate precise management of handling apparatus 500 movements, particularly in embodiments such as illustrated in FIGS. 5A-5D where handling apparatus 500 engages stack 498 from the top down to target storage element 499.

It is noted that the FIGS. 4A-5D illustrations are provided by way of example only, and not by way of limitation. In particular, receptacles 401-40n depicted in FIGS. 4A-4C need not be of uniform size and shape; embodiments of sample storage component 332 (such as depicted in FIG. 4A) are contemplated in which respective receptacles 401-40n are selectively configured to have non-uniform dimensions in the x, y, and z directions. In accordance with some embodiments, receptacle 401, for example, may be deeper (in the y direction) than receptacle 402; in such an arrangement, receptacle 401 may accommodate higher stacks of storage elements 420 than receptacle 402, assuming that storage elements 420 of similar size are maintained at both receptacles 401 and 402. Similarly, as noted above and as depicted in FIG. 4B, various stacks of storage elements 420 may be of differing heights (i.e. may maintain different numbers of storage elements 420 or the same number of storage elements 420 having differing dimensions in the y direction, for example) at any given time during use of receptacle 402.

As set forth above, a sample storage component 332 may maintain a plurality of receptacles 401-40n, each of which is configured and operative to support a plurality of storage elements 420 in a two dimensional configuration on a support surface 410. In the FIG. 4B embodiment, receptacle 402 supports a two dimensional configuration of stacked storage elements 420, creating a three dimensional arrangement in which each storage element is individually addressable and directly accessible. In that regard, it is noted that a system and method of storage element archiving and retrieving in accordance with the present disclosure facilitate access to any given storage element 420 in a single operation, i.e. it is not necessary to access, engage, remove, or otherwise to manipulate a plurality of storage elements 420 prior to accessing a target storage element 499. The two and three dimensional receptacle configurations (represented by FIGS. 4C and 4B, respectively), in combination with appropriate handling apparatus (as shown and described with reference to FIGS. 5A-5D) enable any target storage element 499 to be accessed and manipulated directly, i.e. without any preliminary or intervening handling operations with respect to other storage elements 420.

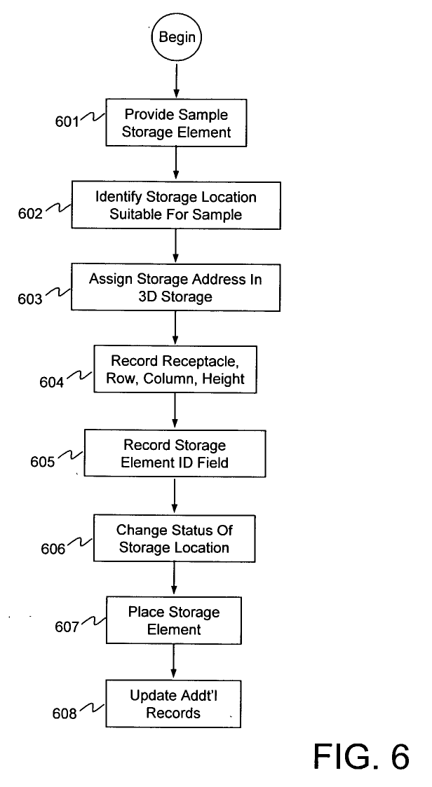

FIG. 6 is a simplified flow diagram illustrating the general operation of one embodiment of a procedure to archive a storage element. A system and method of sample storage may generally be operable to place or to archive a sample storage element 420 in a sample storage receptacle as set forth in detail above; the term “storage element” in this context encompasses both sample carriers as well as sample carrier receivers (such as micro-well plates or other structures, for example) as described and claimed in the related applications. Initially, providing such a storage element as indicated at block 601 in FIG. 6 may include, among other things, loading sample material into various wells or containers in the storage element, preparing the storage element for archiving (such as by sealing one or more containers or the entire storage element, for example), making the storage element available to robotic handling mechanisms, and the like.

Identifying a suitable storage location as indicated at block 602 may include interrogating a database or other data structure maintaining detailed records of a storage facility. In the FIG. 3 embodiment, for example, archive facility 360 generally comprises archive 330 including robotics 331 and associated computer hardware and software, sample storage component 332, and data storage medium 334. The operation indicated at block 602 generally represents identifying a specific address or storage location in sample storage 332 which is suitable to accommodate a storage element; such identifying may depend upon the nature and complexity of the storage strategy utilized at one or more receptacles in sample storage 332; details regarding the storage strategy and environmental conditions of sample storage 332, in general, and each receptacle, in particular, may be retained in data storage medium 334. Such details may be accessed and analyzed (for example, by processor 321 and memory 322 at controller 320) to identify a suitable storage address for a particular storage element.

Given the storage strategy illustrated in FIGS. 4A and 4B, for example, identifying a storage location suitable for a storage element to be archived may include interrogating some or all of the various data record fields noted above: receptacle (e.g. 402); row (i.e. x coordinate), column (i.e. z coordinate), and stack position (i.e. y coordinate); storage element identification (e.g. 499), if present, associated with the storage element to be archived; and state (e.g. occupied, empty, reserved). Given the storage strategy illustrated in FIG. 4C, for example, the simplified data model may enable accurate identification of a suitable storage address using fewer data fields (the stack position coordinate, for example, may be unnecessary).

An unoccupied and unreserved storage location, for example, may be a good candidate location to accommodate the storage element to be archived; additional factors may also affect whether the storage location is suitable. For example, different receptacles in a single sample storage component 332 may be maintained under different environmental conditions; different receptacles in a single sample storage component 332 may also utilize different storage strategies, respectively enabling archival of storage elements in a stacked configuration (FIGS. 4A and 4B) and archival of storage elements on end (FIG. 4C). While some storage elements stacked in the FIG. 4B embodiment may be sealed to tolerate rotation for storage on end as in FIG. 4C, others may not be so adapted for the on end storage strategy. Accordingly, identifying a specific location at which to archive a given storage element may involve not only identifying an unoccupied and unreserved address in three dimensional space, but also confirming that the identified candidate storage address satisfies the requirements of both the samples as well as the storage element.

The storage element to be archived may be assigned to a particular storage location as indicated at block 603. Assigning a storage location may include writing or updating data record fields associated with the storage address for subsequent reference and retrieval. Upon assigning a storage element to a particular storage address, for example, the state field for that storage location may be changed from empty to occupied or reserved (block 606). Additional recordation of identifying data is indicated at blocks 604 and 605. Recording data for the receptacle, row, column, and height fields (block 604) may accurately define the storage address within the three dimensional space of sample storage 332. Recording data for the storage element identification field (block 605) may enable a particular storage element to be identified at all times; this data field may be of particularly utility in dynamic storage embodiments, where storage elements are relocated as others are retrieved, for example, as set forth in detail above with reference to FIGS. 4B and 5A-5D.

Placing the storage element to be archived in the identified location as indicated at block 607 may include using one or more robotic handling devices or other automatic mechanisms as described above. Storage element handling apparatus may be operative in accordance with control signals transmitted from a computer or microcontroller as is generally known in the art. As describe above with reference to the FIG. 3 embodiment, for example, mechanical controller 320 (under control of processor 321) may transmit appropriate control signals or other data and instructions to affect operation of the storage element handling device through mechanical interface 323. During operations in accordance with the FIG. 6 embodiment, such control signals may be a function of the data record fields maintained and updated at data storage medium 334.

It will be appreciated that the disclosed system and method of archiving storage elements may benefit from data acquisition and analysis related to many aspects of system functionality. Accordingly, updating additional records as indicated at block 608 may include documenting some or all of the following: the date and time of archival; the processing overhead required to identify a suitable storage address; accuracy, handling characteristics, responsiveness, and other monitored parameters of robotic or automated equipment; other information related to system diagnostics; current capacity of sample storage 332 and estimates of sample or storage element throughput rates; and the like.

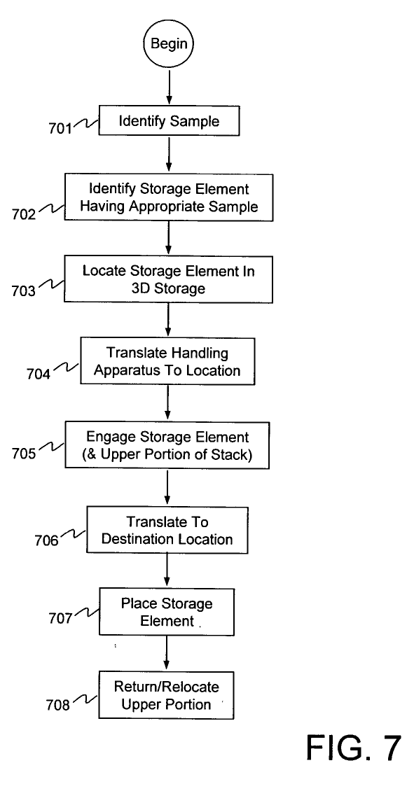

FIG. 7 is a simplified flow diagram illustrating the general operation of one embodiment of a procedure to remove a storage element from a sample storage receptacle. Initially, identifying a sample to be retrieved (block 701) may include interrogating a database to locate a particular sample which is appropriate for the experiment or test to be performed. In particular, one or more samples contained in archive 330 may be acceptable or preferred for myriad experimental purposes depending upon, inter alia, the nature of the experiment, the type and quantity of sample desired, the sample storage medium on which the sample is stored, and the like. A more detailed discussion of these factors can be found in the related applications; the present disclosure is not intended to be limited in any way by the parameters utilized to select a sample appropriate for a particular experimental investigation.

Identifying a storage element containing one or more appropriate samples (block 702) may include interrogating a database to ascertain a location or address of a selected sample in the three dimensional space of sample storage 332. As set forth in detail above and in the related applications, each storage element and its respective information, including information identifying one or more samples contained in the storage element, may be individually addressed and catalogued, for example, in data storage medium 334 which is, in turn, accessible by processors 311 and 321 at coordinator 310 and controller 320, respectively. The foregoing elements; or any combination or equivalents thereof, may identify one or more target storage elements maintaining selected sample material.

It will be appreciated that various methods of identifying a storage element may include, for example, comparing storage element identification fields. In some embodiments, detailed database records may identify every sample contained in a storage element as set forth in detail in the related applications; such records may be associated with the storage element identification field described above, enabling particular sample material to be located within a given storage element. Accordingly, identifying a storage element as indicated at block 702 may include retrieving a storage element identification field which matches other data records associating that storage element identification with a sample which meets specified criteria.

As indicated at block 703, a system and method of retrieving a storage element may locate a target storage element containing a selected sample within the three dimensional space of sample storage 332 using addressing data as set forth above. In some embodiments employing detailed data models such as those described above, locating the target storage element may occur simultaneously with, or in conjunction with, identifying the storage element at block 702. For example, where the storage element identification field is continuously associated with the receptacle, row, column, and height (where required) fields, and these latter fields are updated dynamically, identifying the target storage element at block 702 may additionally include accessing enough of the other data fields to locate that storage element in three dimensional space. In some embodiments, a receptacle in which the target storage element is archived may be opened, translated as indicated in FIG. 4A, rotated, or otherwise manipulated, either manually or automatically, to allow access by appropriate robotics as described above with reference to FIGS. 5A-5D.

Additionally, it is noted that the procedures described above with reference to block 702 and 703 may affect operations at block 704. As indicated at block 704, a handling apparatus or storage element manipulation mechanism may be translated to the appropriate address in sample storage 332. The type, orientation, and motion of the handling apparatus employed at block 704 may be selected, at least in part, as a function of the type, size, and structure of the receptacle housing the target storage element, as well as the particular storage strategy utilized at the receptacle. Where storage elements are stacked (as in FIGS. 4A and 4B) in the target receptacle, for example, the handling apparatus may be translated in a particular orientation, whereas the same handling apparatus may be rotated or otherwise manipulated properly to engage a storage element archived on end (as in FIG. 4C). Alternatively, different handling mechanisms may be employed for the different storage strategy embodiments; since the location and receptacle storage strategy are known based upon the procedures described above with reference to blocks 702 and 703, an appropriate handling apparatus may be dispatched at block 704 to retrieve the target storage element.

Gripping or engaging the target storage element as indicated at block 705 may generally comprise the structure and operability set forth above in detail with reference to FIGS. 5A-5D. In some storage strategies, a handling apparatus may engage an upper portion of a stack of storage elements; alternatively, the handling apparatus may simply engage the selected storage element.

The target storage element may be translated to a destination (block 706) and placed in a particular orientation (block 707) substantially as set forth above. In a stacked storage element strategy, the upper portion of the stack from which the target storage element has been retrieved may be returned or relocation as indicated at block 708. Subsequent storage element manipulation, sample removal and processing, and utilization of other automated mechanisms or apparatus may be a function of the nature and characteristics of the experiment to be conducted and other factors.

It will be appreciated that storage element addressing or location information may be stored in a data storage medium 334 as described above with reference to FIG. 3, and may enable a laser or optical device (not shown) to facilitate location, retrieval, manipulation, and replacement of any given storage element in sample storage 332 of archive 330; similarly, the system may be apprised, through updated data records, of storage elements which have been removed such that a detailed search of the entire archive facility or sample storage component may not be required for subsequent sample identification, addressing, and retrieval operations.

It will also be appreciated that various alternatives exist with respect to the embodiments illustrated in FIGS. 6 and 7, and that the presented order of the individual blocks is not intended to imply a specific sequence of operations to the exclusion of other possibilities; the particular application and overall system requirements may dictate the most efficient or desirable sequence of the operations set forth in FIGS. 6 and 7.

The present invention has been illustrated and described in detail with reference to particular embodiments by way of example only, and not by way of limitation. Those of skill in the art will appreciate that various modifications to the disclosed embodiments are within the scope and contemplation of the invention. Therefore, it is intended that the invention be considered as limited only by the scope of the appended claims.

What is claimed is:

1. An archive comprising:
a receptacle having a support surface; and
a plurality of storage elements arranged in a two dimensional configuration on said support surface.

2. The archive of claim 1 wherein each of said plurality of storage elements is individually addressable.

3. The archive of claim 1 further comprising a handling apparatus selectively operative to engage targeted ones of said plurality of storage elements.

4. The archive of claim 1 wherein each of said plurality of storage elements is oriented on end.

5. The archive of claim 1 wherein one or more of said plurality of storage elements are stacked.

6. The archive of claim 5 wherein each of said plurality of storage elements includes interlocking structural features operative to prevent relative movement of said one or more storage elements when stacked.

7. The archive of claim 5 further comprising a stabilizing structure extending from said support surface and operative to prevent relative movement of said one or more storage elements when said one or more storage elements are stacked.

8. The archive of claim 5 wherein each of said plurality of storage elements is not of uniform depth relative to others of said plurality of storage elements.

9. The archive of claim 5 further comprising a handling apparatus selectively operative to engage a targeted one of said plurality of storage elements and to manipulate said targeted one of said plurality of storage elements and ones of said plurality of storage elements stacked thereon as a unit.

10. The archive of claim 2 further comprising a data structure maintaining information associating each of said plurality of storage elements with a unique storage address.

11. An archive comprising:
a receptacle supporting a plurality of storage elements arranged in a two dimensional configuration of stacks; and
a handling apparatus selectively operative to access a targeted one of said plurality of storage elements directly.

12. The archive of claim 11 wherein each of said plurality of storage elements is individually addressable.

13. The archive of claim 11 wherein said receptacle comprises a stabilizing structure operative to prevent relative movement of storage elements when one or more of said plurality of storage elements are stacked.

14. The archive of claim 11 wherein said handling apparatus is selectively operative to manipulate said targeted one of said plurality of storage elements and ones of said plurality of storage elements stacked thereon as a unit.

15. The archive of claim 14 wherein each of said plurality of storage elements is not of uniform depth relative to others of said plurality of storage elements.

16. The archive of claim 12 further comprising a data structure maintaining information associating each of said plurality of storage elements with a unique storage address.

17. A method of archiving a storage element comprising:
providing a storage element;
identifying a candidate storage location in a two dimensional configuration in a receptacle;
assigning an address representing said candidate storage location to said storage element; and
placing said storage element in said receptacle at said address responsive to said identifying and said assigning.

18. The method of claim 17 wherein said providing comprises loading sample material to be archived into said storage element.

19. The method of claim 17 wherein said providing comprises sealing said storage element.

20. The method of claim 17 wherein said identifying comprises retrieving data records associated with said candidate storage location and said receptacle from a data structure.

21. The method of claim 20 wherein said identifying further comprises confirming that said candidate storage location is unoccupied and unreserved.

22. The method of claim 21 wherein said identifying further comprises confirming that said candidate storage location satisfies requirements of sample material in said storage element.

23. The method of claim 17 wherein said assigning comprises associating said address with said storage element and writing information regarding said associating in a data storage medium.

24. The method of claim 17 further comprising updating data record fields associated with said address in a data storage medium.

25. The method of claim 17 wherein said placing comprises utilizing a handling apparatus operative to manipulate said storage element into a selected position and orientation at said address.

26. The method of claim 17 wherein said receptacle supports a two dimensional configuration of stacked storage elements and wherein said identifying comprises selecting a candidate storage location in three dimensional space in said receptacle.

27. The method of claim 26 wherein said placing comprises utilizing a handling apparatus operative to manipulate said storage element into a selected position and orientation at said address.

28. A method of retrieving a storage element comprising:
identifying a storage element maintaining a selected sample;
locating said storage element at an address in a two dimensional configuration in a receptacle;
translating a handling apparatus to said address at said receptacle; and
retrieving said storage element in accordance with said identifying and said locating.

29. The method of claim 28 wherein said identifying comprises retrieving data records associated with said storage element from a data structure.

30. The method of claim 28 wherein said locating comprises retrieving data records from a data structure, said data records associated with at least one of said storage element, said address, and said receptacle.

31. The method of claim 28 wherein said translating comprises selecting said handling apparatus in accordance with a storage strategy employed at said receptacle.

32. The method of claim 28 further comprising, responsive to said retrieving, updating data records associated with said address in a data structure.

33 The method of claim 28 wherein said receptacle supports a two dimensional configuration of stacked storage elements and wherein said locating comprises selecting said storage element in three dimensional space in said receptacle.

34. The method of claim 33 wherein said retrieving comprises utilizing a handling apparatus operative to manipulate said storage element and additional storage elements stacked thereon as a unit.

35. An archive comprising:
a receptacle having a support surface; and
a plurality of storage elements arranged in a two dimensional configuration on said support surface, wherein each of said plurality of storage elements is individually addressable and directly accessible.

36. The archive of claim 35 further comprising a handling apparatus selectively operative to engage targeted ones of said plurality of storage elements.

37. The archive of claim 35 wherein each of said plurality of storage elements is oriented on end.

38. The archive of claim 35 wherein one or more of said plurality of storage elements are stacked.

39. The archive of claim 38 wherein each of said plurality of storage elements includes interlocking structural features operative to prevent relative movement of said one or more storage elements when stacked.

40. The archive of claim 38 wherein each of said plurality of storage elements is not of uniform depth relative to others of said plurality of storage elements.

41. The archive of claim 38 further comprising a handling apparatus selectively operative to engage a targeted one of said plurality of storage elements and to manipulate said targeted one of said plurality of storage elements and ones of said plurality of storage elements stacked thereon as a unit.

42. An archive comprising:
a receptacle having a support surface;
a plurality of storage elements arranged in a two dimensional configuration of stacks on said support surface, wherein each of said plurality of storage elements is individually addressable; and
a handling apparatus selectively operative to engage a targeted one of said plurality of storage elements and to manipulate said targeted one of said plurality of storage elements and ones of said plurality of storage elements stacked thereon as a unit.

43. The archive of claim 42 wherein said handling apparatus is operative to access targeted ones of said plurality of storage elements directly.

44. The archive of claim 42 wherein each of said plurality of storage elements includes interlocking structural features operative to prevent relative movement of said one or more storage elements when stacked.

45. The archive of claim 42 further comprising a stabilizing structure extending from said support surface and operative to prevent relative movement of said one or more storage elements.

46. The archive of claim 42 wherein each of said plurality of storage elements is not of uniform depth relative to others of said plurality of storage elements.

47. The archive of claim 42 further comprising a data structure maintaining information associating each of said plurality of storage elements with a unique storage address.
